(19) United States
(12) Patent Application Publication
(10) Pub. No.: US 2010/0318746 A1
(43) Pub. Date: Dec. 16, 2010

(54) MEMORY CHANGE TRACK LOGGING

(75) Inventors: Ian Troxel, Aurora, CO (US); Paul Murray, Littleton, CO (US)

Correspondence Address: MILES & STOCKBRIDGE PC, 1751 PINNACLE DRIVE, SUITE 500, MCLEAN, VA, 22102-3833, US

(73) Assignee: SEAKR ENGINEERING, INCORPORATED, Centennial, CO (US)

(21) Appl. No.: 12/484,000

(22) Filed: Jun. 12, 2009

(51) Int. Cl. G06F 12/00; G06F 1/12; G06F 12/08; G06F 12/02; G06F 9/44

(52) U.S. Cl. 711/141; 711/170; 711/163; 711/162; 711/161; 710/260; 713/375; 712/220; 712/E09.001; 711/E12.001; 711/E12.002; 711/E12.026

(57) ABSTRACT

A method for tracking memory changes includes defining a change-track area of memory including at least one memory address range for which changes will be tracked. The method also includes allocating a protected log region of memory for storing a change-track log and selecting an operational mode for change tracking from among a plurality of modes, the selected operational mode having criteria for tracking memory changes. The method includes detecting memory transactions using a memory logging module and generating a transaction record for each memory transaction that occurs in the change-track are of memory and which meets the criteria. The transaction records can be stored in the change-track log.

Embodiments of the present invention relate generally to electrical memory devices and, in particular, to a method and system for tracking and recording changes to a memory and restoring memory based on the recorded changes.

One exemplary embodiment is a method for tracking memory changes. The method includes defining a change-track area of memory having at least one memory address range for which changes will be tracked and allocating a protected log region of memory for storing a change-track log. An operational mode for change tracking is selected from among a plurality of modes, the selected operational mode having criteria (or a criterion) for tracking memory changes. Memory transactions are detected using a memory logging module. The method also includes generating a transaction record for each memory transaction that occurs in the change-track area of memory and which meets the criteria, and storing the transaction record in the change-track log.

Another exemplary embodiment is a system for tracking memory changes. The system includes a memory, a processor and a memory transaction logging module. The memory includes a first region identified as a change-track region and a second region allocated as a protected log region, the change-track region having one or more memory areas for which changes will be tracked. The processor can be coupled to the memory via a bus or any other suitable wired or wireless link. The memory transaction logging module is adapted to: provide an operational mode for tracking changes including a criteria for logging memory transactions; detect memory transactions on the bus; and store transaction details for any memory transaction that is directed to the change-track region of memory and that meets the criteria.

### BRIEF DESCRIPTION OF THE DRAWINGS

FIG. 1 is a block diagram of an exemplary embodiment of a system for tracking and recording memory changes with modified (or instrumented) software;

FIG. 2 is a block diagram of an exemplary embodiment of a system for tracking and recording memory changes with a separate software change logging process or module;

FIG. 3 is a block diagram of an exemplary embodiment of a system for tracking and recording memory changes with an interrupt handling module;

FIG. 4 is a block diagram of an exemplary embodiment of a system for tracking and recording memory changes with a monitoring device;

FIG. 5 is a block diagram of an exemplary embodiment of another system for tracking and recoding changes with a monitoring device;

FIG. 6 is a block diagram of an exemplary embodiment of another system for tracking and recoding changes with a monitoring device;

FIG. 7 is a block diagram showing data flow during a processor memory restoration using the recorded memory change information;

FIG. 8 is a flowchart of an exemplary embodiment of a method for memory change tracking and recording; and

FIG. 9 is a flowchart of an exemplary embodiment of a method for using recorded memory change information to restore another memory.

### DETAILED DESCRIPTION

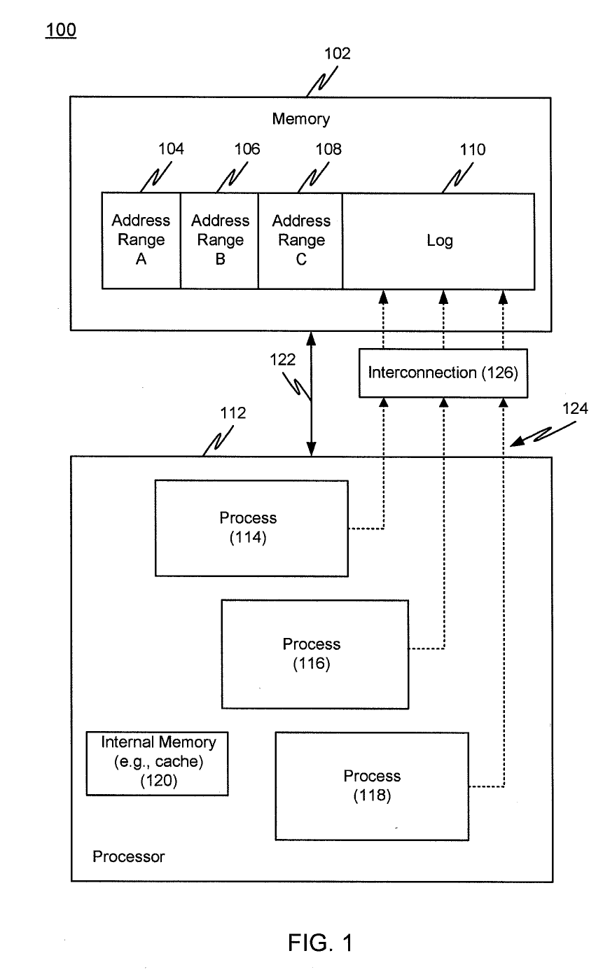

FIG. 1 shows a block diagram of an exemplary embodiment of a system for tracking and recording memory changes with modified (or instrumented) software. In particular, the system 100 includes a memory 102. The memory 102 includes an address range A 104, an address range B 106, an address range C 108, and a protected log region 110. The system 100 also includes a processor 112 having a plurality of processes (114-118) and an internal memory 120 (e.g., cache memory). The exemplary embodiment of FIG. 1 shows a processor executing three processes for illustration purposes. It will be appreciated that an actual implementation or embodiment may include more or less processes executing on a processor. An interconnection means 122 couples (or connects) the memory 102 and the processor 112. The processor 112 and processes (114-118) are adapted to optionally first write into the internal memory 120 and then into the log 110 via instrumented logical connections 124 that could be physically routed through the interconnection means (126) or any other means of interconnection.

In operation, certain memory transactions can be recorded and later retrieved. For example, as the processor 112 executes processes 114-118 the processor 112 may access the memory 102 via memory transactions (e.g., read and write operations). It may be desirable to record certain ones of the memory transactions for later use such as recovery from errors, restoration of another memory, diagnostic or other operational analysis, or the like.

In the exemplary embodiment shown in FIG. 1, three address ranges have been defined: address range A 104, address range B 106, and address range C 108. For tracking and recording memory changes, one or more of these ranges can be defined as a change-track area of memory. For example, address range A 104 and address range C 108 may be defined as comprising the change-track area of memory. Accordingly, transactions occurring in the defined ranges (e.g., address ranges A and C) will be recorded by the change-track logging process or device (assuming the memory transaction meets any other tracking criteria). Memory transactions occurring in address range B 106 will not be recorded in this exemplary configuration. It will be appreciated that three memory address ranges have been shown for illustration purposes and an actual implemented embodiment may include more or less memory address ranges or more or less than two areas for change-tracking.

Memory transactions can be detected by a memory logging module that can be a single module or be a distributed module within the system 100. For example, the memory logging module can include software instructions that, when executed, cause the processor to detect memory transactions, generate a memory transaction record and log memory transaction records meeting the criteria described below for recording. Once detected, memory transactions can be evaluated according to address and operational criteria. A memory transaction record can be generated for those transactions meeting the defined or selected criteria. The memory transaction records can be recorded to the protected log region 110. The protected log region 110 may be allocated as a protected region of memory in order to help ensure that the log memory does not get corrupted by a process executing on the processor 112. The memory transactions can include details such as type of transaction, address (or addresses) value referenced, and the subject data value. Other information could also be recorded such as control signals, a time stamp, device or processor identification, or the like. In general, any information that may be useful in later restoring another processors memory, or reconstructing or analyzing memory transactions can be stored as part of the transaction record.

Although shown in FIG. 1 as part of the memory 102, it will be appreciated that the protected log region 110 can be a part of the internal processor memory (112), part of the same memory containing the address ranges (104-108) or can be implemented in another internal or external device and be accessible over an interconnection means such as a wired, wireless, or optical network or bus. The log region can be comprised of one or more memories and/or memory areas.

As memory transactions occur on the bus 120 (or other memory-processor interface such as cache memory boundary) a record of the transactions can be made by the change-track logging module. It will be appreciated that the memory 102 and the bus 120 may comprise multiple physical and/or logical devices and a memory transaction may span two or more of these physical and/or logical devices.

As shown in FIG. 1, the processes (114-118) include modified software (or instrumentation software for memory change-track logging) that makes it possible for the processes to detect memory transactions, generate a transaction record for appropriate transactions and record the transaction record via logical connections 122 in the protected log region 110. The modified software can include a logging process that operates according to an operational mode. The operational mode can be selected from among several modes including, but not limited to: only recording address values for memory write transactions; only recording address values for read and write transactions; recording both address values and data values for write transactions only; and recording both address values and data values for read and write transactions. Also, memory control signals can be monitored for changes and recorded. Another operating mode can include the method or system evaluating the type of data being processed (e.g., the system may suspend change-tracking during transfers of bulk data such as image data). It will be appreciated that other operational modes may be implemented depending on a contemplated embodiment.

The modified software can be implemented directly (i.e., included in the source code and built as part of the software) or implemented as a library that can “overload” memory functions (i.e., include functions that replace existing memory functions with ones containing software code for memory change-track logging) and can be included in the software processes at the compile stage or linking stage (or any stage in the software design, build or execution process). Also, the modified software can include modified firmware or modified operating system software.

The address ranges A-C shown in FIG. 1 have not been shown in the subsequent figures described below in order to simplify those figures and focus the description on other features of the embodiments. However, it will be appreciated that the memory of the other embodiments can include a change-track area that includes one or more address ranges or other memory areas that have been defined for tracking the changes occurring therein. Also, change-track memory areas could be defined based on logical or physical devices, logical or physical addresses, bus areas or addresses, or a combination of the above.

The processor 112 (and other processors described herein) can be any device that executes an algorithm or otherwise processes data, including, but not limited to, sequential microprocessors, vector microprocessors, microcontrollers, digital signal processors (DSPs), field programmable gate arrays (FPGAs), graphics processing units (GPUs), application specific integrated circuits (ASICs), or the like. As used herein “processor” can refer to a unitary processor or a distributed processor; processor can also refer to a multi-core processor including a hardware implementation (e.g., multiple processors packaged in a single device or constructed on a single substrate) or a firmware implementation (e.g., so-called “soft core” configured onto a programmable logic device). The memory 102 (and other memory devices described herein) can include any internal or external device or combination of devices used to store data or instructions or both.

It will be appreciated that different schemes can be used to store the memory transactions in the change-track log such as storing the most recent, storing all, or another scheme based on a contemplated embodiment.

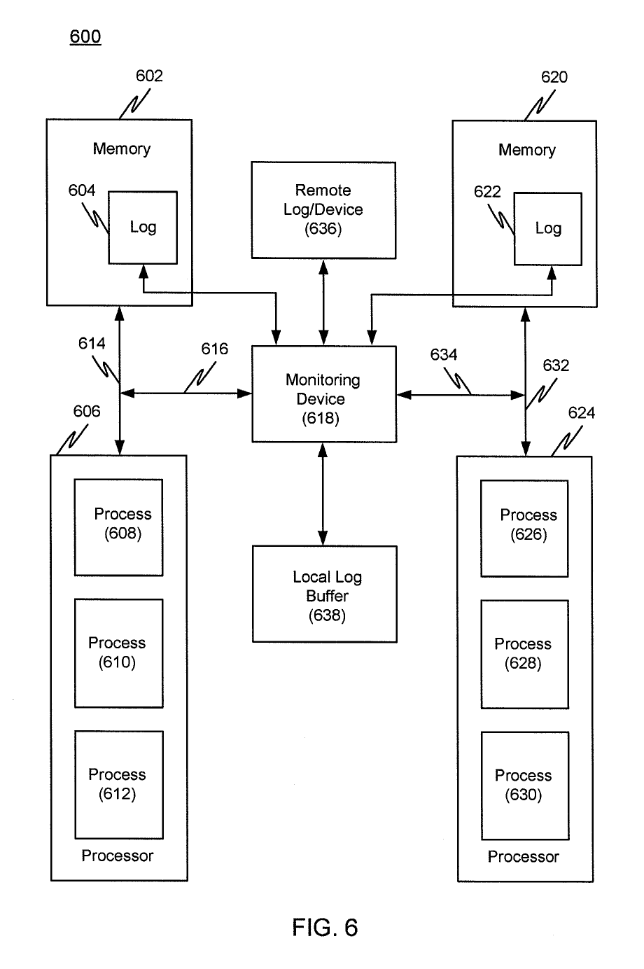

The recorded memory transactions can be retrieved and used to synchronize two memories. For example, in a multi-processor system one processor may experience an error condition that requires the processor to be reset or rebooted. During reboot time, the processor is not processing data and therefore may be out of synchronization with other processors once it resumes executing application software. The recorded memory transaction can be retrieved and transmitted to the processor being rebooted in order to bring its memory up to a current state and make it possible for the rebooted processor to resume synchronous operation with the other processors in the system. The multi-processor restore operation will be described in greater detail below with respect to FIG. 6.

In addition to being useful for restoring a rebooted or reset processor's memory, the memory change-track log may also have other uses such as diagnostics, audit trail, or any other use where retrieving recorded memory transactions may be required, desired or helpful.

The process of tracking changes to a memory may be carried out continuously or intermittently. Intermittent operation may be initiated in response to a signal. For example, in the scenario described above in which one processor of a multi-processor system requires resetting (or rebooting), the function of resetting the processor could also include generating a signal to request that memory change tracking be initiated. Thus, as the processor is being reset, memory transactions are being recorded in order to restore the processor once it resumes operation. Other types of signals can be used to initiate or terminate memory change tracking and can be determined based on a system design or operational requirements.

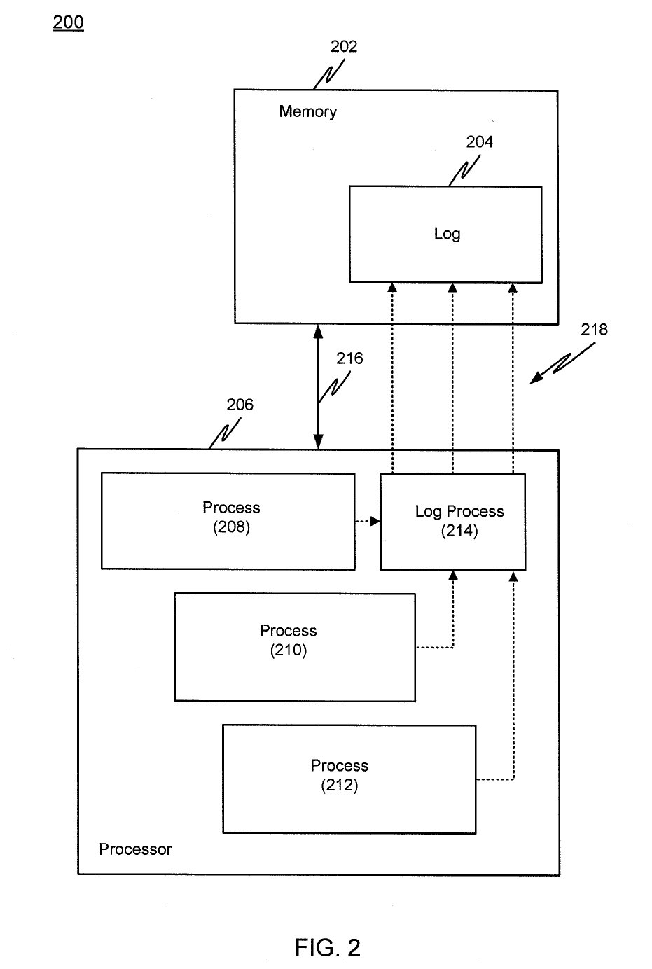

FIG. 2 is a block diagram of another exemplary embodiment of a system for tracking and recording memory changes with a separate software change logging process. In particular, the system 200 includes a memory 202. The memory 202 includes a protected log region 204. The system 200 also includes a processor 206 having three processes (208-212) and a log process 214. A bus direct connection or any other means of interconnection 216 couples (or connects) the memory 202 and the processor 206. The processor 206 and the log process 214 are adapted to write into the log 204 via instrumented logical connections 218. The logical connections could potentially use the interconnection method used by the processor to access memory or this process can be done through additional methods.

In operation, the software executing on the processor 206 can be modified to include a separate log process 214 that monitors the memory transactions of the other processes (208-212) and records the transactions meeting defined address and operational mode criteria. The separate logging process 214 can make it possible to provide additional security by isolating the logging process. The separate logging process 214 may be incorporated into the software for execution on the processor 206 via the direct source modification or library options described above, or by other suitable methods such as applying a patch to the operating system kernel.

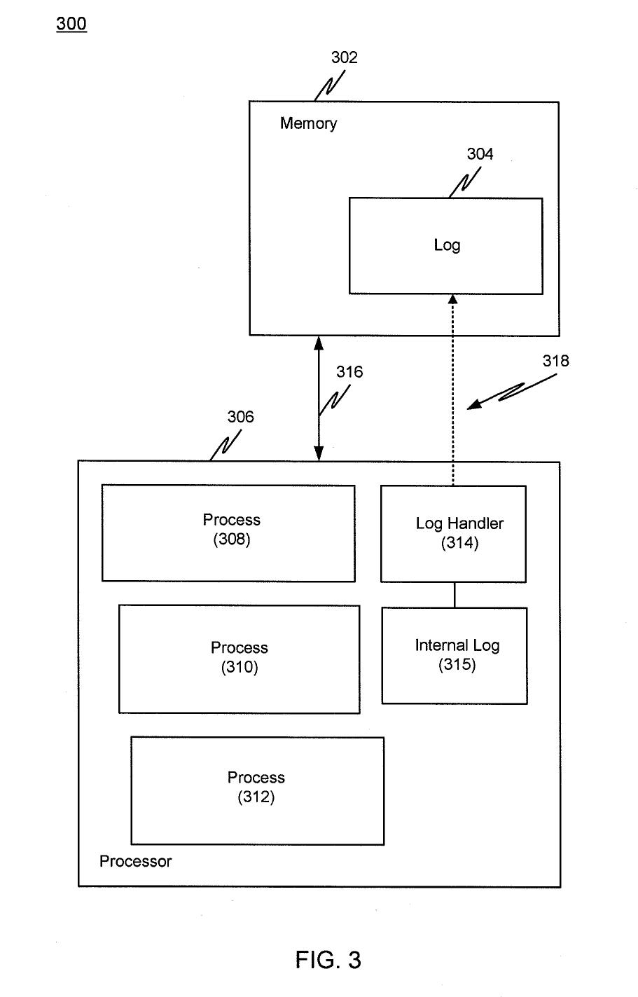

FIG. 3 is a block diagram of another exemplary embodiment of a system for tracking and recording memory changes with an interrupt handling module. In particular, the system 300 includes a memory 302. The memory 302 includes a protected log region 304. The system 300 also includes a processor 306 having a plurality of processes (308-312) and a log interrupt handler 314. A bus or any other means of interconnection 316 couples (or connects) the memory 302 and the processor 306. The processor 306 and the interrupt handler 314 are adapted to write into the log 304 via logical connections 318.

The interrupt handler embodiment of the system 300 may not require modification of the software of the processes (308-312). Further, the interrupt handler embodiment may provide additional security because the logging mechanism is independent from the application processes (308-312).

Processors typically include an interrupt generating/handling mechanism that can be used to detect events such as memory transactions and generate an interrupt signal in response (e.g., a cache miss protocol). A process (i.e., an interrupt handler) can be assigned to respond to the interrupt signal. For processors or other devices that do not include an implementation of a conventional interrupt/interrupt handler system, other hardware or software mechanisms can be implemented to provide an analogous function that can execute independently on the device. For example, a separate hardware circuit implemented on an FPGA could be designed and implemented to monitor memory transactions and record those transactions meeting address and/or other criteria.

In operation, the processor 306 includes an interrupt mechanism that can be used to generate an interrupt when a memory transaction occurs. When one of the processes (308-312) performs a memory transaction an interrupt is raised and the log handler 314 is executed, the memory transaction can be stored locally in the internal log 315. The log handler 314 can evaluate the memory transaction to determine if the transaction is occurring in a change-track region of the memory and also to determine if the memory transaction meets any other operational criteria. Although shown as part of the processor 306, the log handler 314 can be an external process or circuit. In addition, the log could be external to the memory (302) or can be kept within memory internal to the processor (306). Such arrangements of the log can also be applied to other embodiments described herein, but have been omitted for the sake of clarity in describing other features.

The system 300 can include means for describing a change-track area of memory such as a table or other data structure including one or more address ranges that correspond to one or more logical or physical devices that can be internal or external to the system 300. The change-track area description can be provided by the processor 306, by the log handler 314 or by another internal or external circuit, process or module.

The system 300 can include means for providing data storage space for use as the protected change-track log 304. The providing means can include allocation of memory by the processor 306, a configuration file or data that indicates a portion of the memory to be allocated as the log 304, or any other suitable means for allocating or defining a region of memory for use as the log 304.

The system 300 can also include means for selecting an operational mode for tracking memory changes having criteria for changes to be tracked. The operational mode can be selected by the processor 306 while executing and may be changeable during execution depending on an operational context. The operational mode could be selected by the log handler 314. Alternatively, the operational mode could be selected by configuration data, hardwired configuration selection, an internal or external device, circuit or module, or any other means suitable for selecting an operational mode. The operational mode can be selected from among the operational modes described above or other modes suitable for use in a contemplated embodiment.

The system 300 can also include means for detecting any memory transaction that occurs in the change-track area and which meets the criteria. Hardware or software memory transaction modules, circuits or devices can be used to detect relevant memory transactions. Also, the system 300 includes means for generating an interrupt signal based on the detection of a transaction of interest. Typically, interrupt signals are generated by hardware sections dedicated to interrupt processing, but other interrupt generation means can be used including dedicated hardware for generating interrupts, a software interrupt generator, or any other means suitable for generating an interrupt signal. The interrupt signal can be a hardware signal (e.g., a signal line provided internally or externally from a device, circuit or module), a software signal (e.g., a semaphore, or the like) or both.

As mentioned, the system 300 includes a log handler 314. The log handler 314 includes means for handling the interrupt signal by storing transaction information associated with the transaction of interest in the change-track log. Such means can include a software module that has been defined as the interrupt handler associated with the interrupt signal for memory transactions. Other interrupt handling structures can be used including an integrated or stand-alone hardware interrupt handler (e.g., an FPGA or portion of an FPGA configured for use as an interrupt handler).

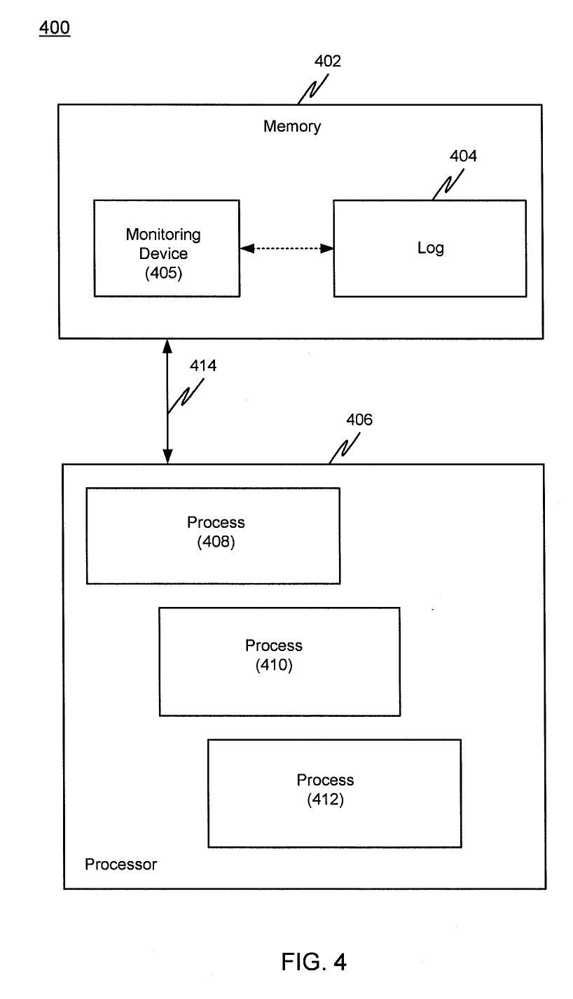

FIG. 4 is a block diagram of an exemplary embodiment of a system for tracking and recording memory changes with a monitoring device. In particular, the system 400 includes a memory 402. The memory 402 includes a protected log region 404 and a monitoring device 405. The system 400 also includes a processor 406 having one or a plurality of processes (408-412). A bus or any other means of interconnection 414 couples (or connects) the memory 402 and the processor 406. The monitoring device 405 is adapted to write into the log 404.

In operation, the monitoring device 405 monitors memory transactions (e.g., by directly monitoring the signals on the bus or any other means of interconnection 414) without interfering in those transactions. Any transactions that occur in the change-track area and also meet any other applicable criteria can be recorded to the log region 404.

Because the monitoring device 405 can monitor memory transactions without modifying, or placing a burden on, the processes or the memory itself, the monitoring device 405 option can make it possible for memory transaction monitoring to occur without an adverse impact on system performance or throughput. However, the monitoring device 405 may require additional specialized hardware for implementation.

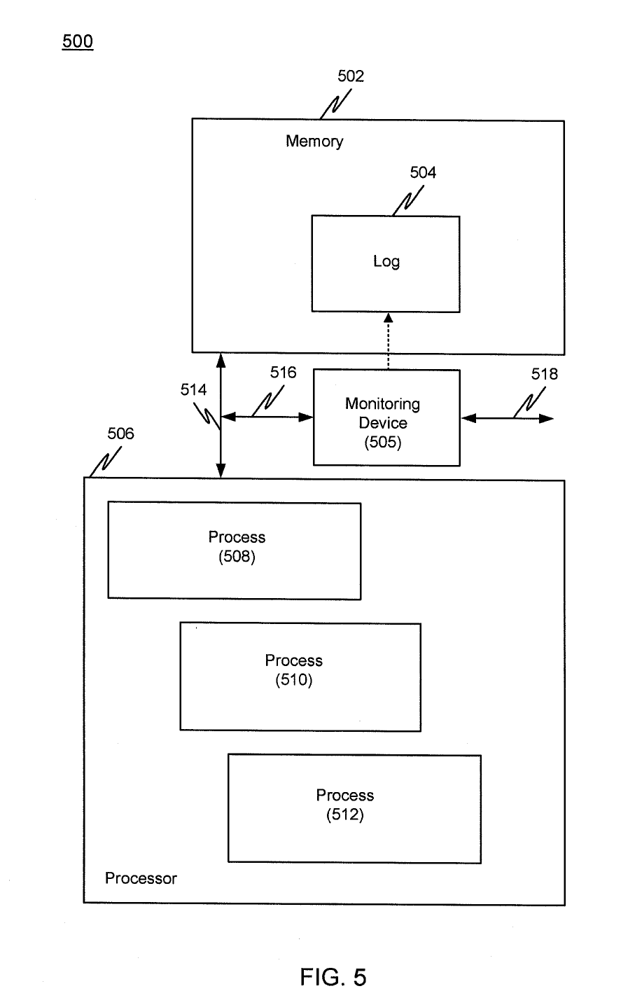

FIG. 5 is a block diagram of an exemplary embodiment of another system for tracking and recoding changes with a monitoring device. In particular, the system 500 includes a memory 502. The memory 502 includes a protected log region 504 and a monitoring device 505. The system 500 also includes a processor 506 having one or a plurality of processes (508-512). A bus or any other means of interconnection 514 couples (or connects) the memory 502 and the processor 506. The monitoring device 505 is coupled to the bus via link 516 and adapted to write into the log 504. The monitoring device 505 may also include an external link 518. The monitoring device 505 can be implemented in hardware or software and can be positioned anywhere in the system within and/or between one or more processors and one or more memories, interconnects, external links or external devices attached to the system via external links.

In operation, the monitoring device 505 monitors memory transactions (e.g., by directly monitoring the signals on the interconnection means 514 via link 516) without interfering in those transactions. Any transactions that occur in the change-track area and also meet any other applicable criteria can be recorded to the log region 504. Also, the monitoring device 505 can provide recorded memory transactions to an external device or system via external link 518.

FIG. 6 is a block diagram of an exemplary embodiment of another system for tracking and recoding changes with a monitoring device. In particular, the system 600 includes a first memory 602 having a first protected log region 604. The system also includes a first processor 606 having one or a plurality of processes (608-612) and being coupled to the memory 602 via any means of interconnection including a wired (e.g., a bus), optical, or wireless link 614. The system 600 also includes another wired (e.g., a bus), optical, or wireless link 616 that couples the link 614 to a monitoring device 618. The system 600 also includes a second memory 620 having a second protected log region 622. The system 600 also includes a second processor 624 having one or a plurality of processes (626-630) and being coupled to the second memory 620 via any means of interconnection 632. The system 600 also includes one or more interconnections 634 that couple the link 632 to the monitoring device 618 through any means of interconnection. The system also includes a remote log/device 636 and a local log buffer 638, both being coupled to the monitoring device 618.

In operation, memory transactions can be generated by each of the processors (606 and 624). The memory transactions associated with one or both processors may be monitored by the monitoring device 618 and a transaction can be recorded if it meets the criteria for change-track logging. It should be appreciated that although two memories and one monitoring device are shown, a system can include additional memories and/or monitoring devices. As such, the embodiment may be implemented with two or more processors.

The monitoring device 618 can record certain memory transactions relating to the processors (606 and 624) to the respective protected log (604 and 622) of the processor. In addition to the protected log regions (604 and 622) the monitoring device 618 can also record memory transactions from one or more processors to a remote log or device 636. In some cases, a remote device may not be able to sustain a data transfer rate sufficient to keep up with a device such as the monitoring device. The monitoring device 618 can use the local log buffer 638 to buffer memory transactions for transfer to the remote log/device 636. Alternatively, an embodiment could include logging the memory transactions to the local log buffer 638.

By providing a monitoring device that can monitor the memory transactions of two or more processors, it is possible for the monitoring device 618 to compare memory transactions from the various processors. The comparison of memory transactions can occur in “real-time” (i.e., as they are occurring) or in a time-delayed manner. This type of comparison can be used in various embodiments described below in more detail.

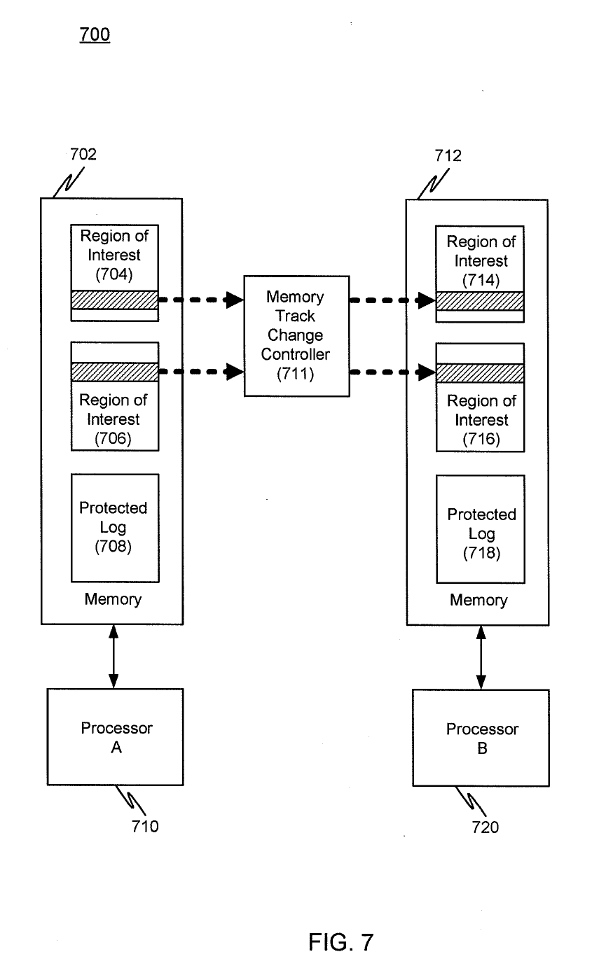

FIG. 7 is a block diagram showing data flow during a processor memory restoration using the recorded memory change information. In particular, a system 700 includes a first memory 702 having two regions of interest (704 and 706) and a protected log region 708. The first memory is coupled to a first processor (“processor A”) 710 and to a memory track change controller 711. The system 700 also includes a second memory 712. The second memory 712 includes two regions of interest (714 and 716) and a protected log region 718. The second memory 712 is coupled to a second processor (“processor B”) 720 and the memory track change controller 711.

In operation, the second memory 712 can be updated to a current state by the memory track change controller 711 transferring changes (hatched areas) made to regions of interest (704 and 706) in the first memory 702 to the corresponding regions of interest (714 and 716) in the second memory 712. The memory changes, while shown for illustration purposes as coming from the first memory 702 to the second memory 712, can also be provided from the protected log 708 of the first memory 702.

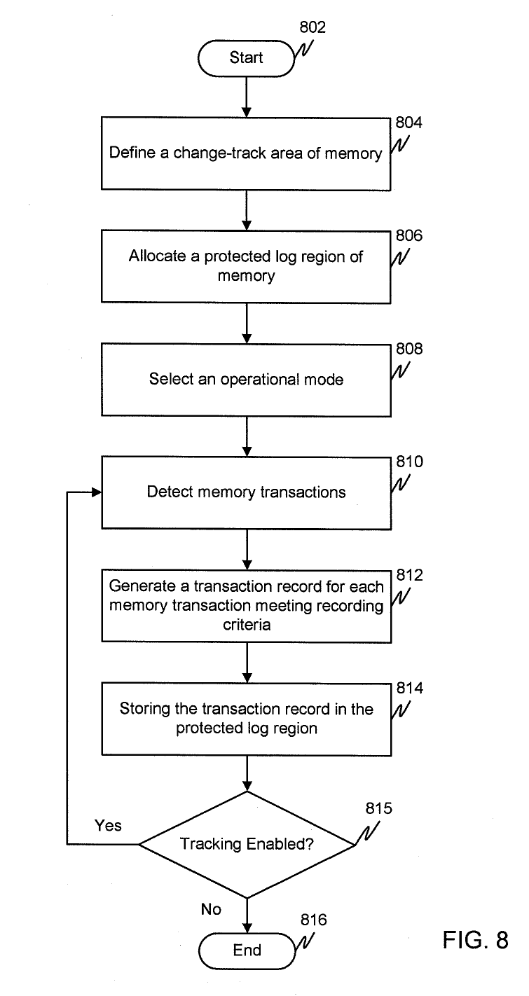

FIG. 8 is a flowchart of an exemplary embodiment of a method for memory change tracking and recording. Processing begins at step 802 and continues to step 804.

In step 804, a change-track area of memory is defined or described. The change track area includes at least one memory address range for which changes will be tracked. Processing continues to step 806.

In step 806, a protected log region of memory for storing a change-track log is allocated. Processing continues to step 808.

In step 808, an operational mode for change tracking is selected from among a plurality of modes. As described above, the selected operational mode can have criteria (or a criterion) for tracking memory changes. Processing continues to step 810.

In step 810, memory transactions are detected using a memory logging module or process. Processing continues to step 812.

In step 812, a transaction record for each memory transaction that occurs in the change-track are of memory and which meets the criteria can be generated. The memory transaction record can include a defined data structure or can be as simple as a few items of data. Processing continues to step 814.

In step 814, the transaction record is stored in the change-track log. If tracking is still enabled (815), then processing can continue back to step 810. If tracking is disabled, processing can move to step 816 where processing ends. It will be appreciated that steps 802-816 can be repeated in whole or in part in order to accomplish a contemplated memory change-track logging task.

It should be appreciated that the exemplary method shown in FIG. 8 can also include more than one type of logging occurring simultaneously, even on the same memory region of interest and even with the same operational mode. Also, a user or controller may stop the current type of logging and continue with a different type and control would flow back to any of steps 804, 806 or 808 depending on the changes made.

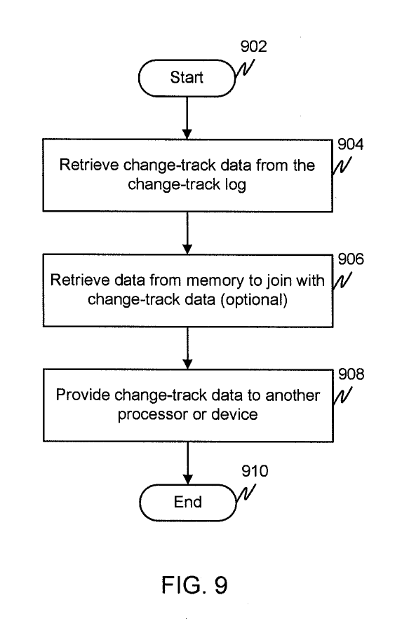

FIG. 9 is a flowchart of an exemplary embodiment of a method for using recorded memory change information to restore another memory. Processing begins at step 902 and continues to step 904.

In step 904, change-track data is retrieved from the change-track log. As described above the change-track data can include address values, data values and other information. Processing continues to step 906.

In step 906, data is retrieved as needed from the memory corresponding to the processor processing the change-track data retrieval operation. Data may be needed from memory in cases where the change-track log does not include data values (e.g., only address values were recorded to the change-track log). The data retrieved from the memory can be joined with the change-track log data for transfer to the processor or other system. Processing continues to step 908.

In step 908, the change-track log data (and possibly data from memory) is provided to another processor or device. Optionally, in a step not shown, the data can be validated or checked for validity prior to being provided to another processor or device. Processing continues to step 910, where processing ends. It will be appreciated that steps 902-910 can be repeated in whole or in part in order to accomplish a contemplated change-track data retrieval operation.

One consideration applicable to any of the embodiments described above that include a log region is how to determine an appropriate log region size. The size of a log region can be based on a number of factors including frequency of memory access, size of the change-track memory area being monitored and length of time that the logging system is predicted to be active. Another consideration is how to handle a situation in which the log region becomes full. Several options can be implemented to handle a log region overflow situation, such as automatically suspending logging activity or continuing logging with some scheme for data replacement. Data replacement can occur in a first-in-first-out (FIFO) method, a last-in-first-out method (LIFO), or via an n-way redundant index-based replacement strategy, or the like. In general, any now known or later developed scheme or method for handling overflow conditions of buffers or queues can be implemented.

Another possible implementation for handling log region overflow conditions is to define a method by which the protected log region can grow. For example, if an overflow condition is imminent or is occurring, the logging process could request an additional allocation of protected log region memory in order to continue logging transactions. Alternatively, the logging process could change logging locations in a hierarchical fashion if the primary log region becomes full. For example, the logging process could send transactions to an external storage device if the local log region becomes full. A mechanism may also be provided for the logging process to release the additionally allocated memory once a need for it has passed (e.g., once logging has stopped and the logged data has been retrieved). A method or process for determining a rollover or overflow location can be implemented in a hierarchical based location system so that a track change processor can determine a subsequent logging location if a currently used location becomes full. For example, referring to FIG. 6, if either one of the logs memories 604 or 622 becomes full, the monitoring device 618 can store the transaction records to the local log buffer 638. Then, if the local log buffer 638 becomes full, the monitoring device can store the transaction records in the remote log/device 636.

Another embodiment for addressing storage issues can include the logging process having multiple operating modes (in addition to the modes discussed above). For example, the logging process may operate in a mode that uses less memory (e.g., logging only address data) for a majority of processing time and may periodically (e.g., once per time period or every n-memory accesses) switch into a mode that stores more data (e.g., recording address values and data values) and which may provide higher fidelity.

As mentioned above, an embodiment can be used as an update and synchronization mechanism for processor lockstep operations (e.g., redundant processors). In such an embodiment, memory transactions of one of the processors can be recorded making it possible to update another processor's memory at a later time by transferring changes made to memory during a given period of time to the other processor. If a processor is determined to be out of lock step (or experiencing an error condition) it may need to be reset or rebooted as described above. The other processors may continue operating and may initiate memory change-track logging. Once the processor experiencing an error has been rebooted and resumes execution, the memory contents can be updated as described above with respect to FIG. 7.

Conventional systems may require that all processors halt while one is rebooting in order to maintain lockstep. In contrast, an embodiment of the present invention can make it possible for the processors that have not suffered an error to continue processing data during a majority of the rebooting process. Because memory changes for the processors that have not suffered an error can be recorded while the erroneous processor is being rebooted. The rebooted processor can be brought into synchronization once it begins operating after reset or reboot. An initial bulk transfer of memory values may need to be transferred to the rebooted processor (e.g. a baseline memory image). At a certain point in the rebooting process, all of the processors may need to be halted for a brief period while any updates recorded in the track change log are transferred to the rebooted processor and applied to the memory image in the rebooted processor. Once the changes have been applied, all of the processors can resume operation and will be operating in lock-step or in some other synchronized fashion. So, an embodiment can make it possible for an increased duration of system functionality (or “up-time”) during a processor reset or reboot as compared to some conventional systems without memory change-track logging.

An embodiment can also be used to determine if redundant processors are in lock-step or some other synchronized fashion (see, e.g., the description of FIG. 6 above). A common approach to determining if two or more processors are in lock-step is to compare their respective memory access patterns and determine whether each processor is initiating memory transactions in exactly the same way (or within a predetermined tolerance or threshold). The memory transaction method of determining processor lock-step operation can be particularly advantageous for memory-intensive processes because the memory transactions are likely a good proxy for overall processor functionality.

Another embodiment of this invention that incorporates the memory transaction method can be employed in comparing data from processors that are not performing traditional lock-step operations. Transaction-based or batch processing are exemplary areas of computing related to this type of processing in which the correctness of processing is determined by comparing the final result of a collection of operations that are together assumed to be atomic. Examples of transaction-based processing include cryptographic processing, image processing, and data mining operations. Testing for failures in this method of computing contrasts to lockstep processing in that each individual operation is not checked (i.e. only the final output checked) and the processing and therefore checking does not have to occur simultaneously. Therefore, a single processor can execute the same algorithm on the same data set in a repetitive and sequential manner (aka temporal redundant processing) and the outputs of each of the sequential atomic processing groups can be compared by monitor 618 in FIG. 6, for example, to determine correctness. This type of processing is especially applicable to applications where comparing values of individual data points may not be as important as determining that the algorithm is proceeding correctly such as image processing. It can be appreciated that this method of processing directly contrasts with lock-step processing but that the same or similar embodiment of the invention can be applied to both types of processing. An embodiment can be used for check-pointing and rollback mechanisms. In some conventional system check-pointing is performed by periodically backing-up or saving a processor's state (e.g., register values) and memory values to an external storage device. If the processor is determined to be in a failed state, then the processor can be “rolled back” to a previous state by reloading the saved processor state data and memory values from a previous checkpoint. In some conventional systems, the processor may need to be halted while the state is copied during a checkpoint operation.

In contrast, an embodiment could include logging memory transactions using the memory change-track logging method. Periodically, a delimiter could be inserted into the log at checkpoint intervals. Thus, it can be possible to reduce processor downtime while check-pointing is occurring because memory change logging can occur while the processor is operating. An embodiment also may make it possible to reduce the time for a roll-back operation because only those memory values that have changed since the last check-pointing operation need to be copied back into memory.

An embodiment can also be used for data coherency schemes (e.g., cache coherency). A region of interest of the cache or memory can be tagged with the appropriate cache coherency state names for a given coherency scheme (e.g., write-exclusive, read-only, etc.) and the logging device or process can be used to detect incorrect addresses to a given area of memory (e.g., writing to a read-only location). Also, an embodiment can be configured to provide updated data to other processors (see, e.g., FIG. 6 and accompanying description above) as may be required by the coherency scheme such as the case in which one processor releases a modified memory location that was once in the write-exclusive state (i.e., the updated value must be passed to the other processors in the system).

Another embodiment can be used for operating system security. For example, a memory change-track logging device or process can be adapted to help ensure that an operating system is maintaining security of certain sensitive regions of memory and that safeguards for those regions are enforced. In a hardware implementation of the logging device or process, additional security may be provided by having a security check function occur in hardware as compared to software security functions that may be easier to compromise. A modification to a sensitive area of memory can be recorded and checked to ensure that safeguard measures are not being circumvented. The memory change-track device or method can be adapted to shut down the processor if a specified sensitive area of memory is accessed (e.g., modifications to the operating system, sensitive application instructions, protected system password areas, or the like). Also, an embodiment (e.g., that shown in FIG. 6) could be adapted to securely load sensitive data into and out of the processor's memory space without risking that the data be available to suspect software. The secure data could be stored in and retrieved from an external or remote device (e.g., remote log/device 636 of FIG. 6) to provide increased security.

The exemplary embodiments described above have included a processor executing three processes for illustration purposes. It will be appreciated that an actual implementation or embodiment may include more or less processes executing on a processor.

An embodiment of the present invention can be used to handle situations in which one or more processors or memories encounters a fault. For example, a fault can arise from the interaction of ionizing radiation with the processor(s) and/or memory device(s). Specific examples of ionizing radiation include highly-energetic particles such as protons, ions, and neutrons. A flux of highly-energetic particles can be present in environments including terrestrial and space environments. As used herein, the phrase “space environment” refers to the region beyond about 50 miles (80 km) in altitude above the earth.

Faults can arise from any source in any application environment such as from the interaction of ionizing radiation with one or more of the processors or memories. In particular, faults can arise from the interaction of ionizing radiation with the processor(s) in the space environment. It should be appreciated that ionizing radiation can also arise in other ways, for example, from impurities in solder used in the assembly of electronic components and circuits containing electronic components. These impurities typically cause a very small fraction (e.g., <<1%) of the error rate observed in space radiation environments.

An embodiment can be constructed and adapted for use in a space environment, generally considered as 80 km altitude or greater, and included as part of the electronics system of one or more of the following: a satellite, or spacecraft, a space probe, a space exploration craft or vehicle, an avionics system, a telemetry or data recording system, a communications system, or any other system where distributed memory synchronized processing may be useful. Additionally, the embodiment can be constructed and adapted for use in a manned or unmanned aircraft including avionics, telemetry, communications, navigation systems or a system for use on land or water.

Embodiments of the method, system and apparatus for memory change track logging, may be implemented on a general-purpose computer, a special-purpose computer, a programmed microprocessor or microcontroller and/or peripheral integrated circuit element, an ASIC or other integrated circuit, a digital signal processor, a graphics processor, a hardwired electronic or logic circuit such as a discrete element circuit, a programmable logic device such as a PLD, PLA, FPGA, PAL, or the like. In general, any process capable of implementing the structures, functions or steps described herein can be used to implement embodiments of the method, system, or device for memory change track logging.

Furthermore, embodiments of the disclosed method, system, and device for memory change track logging may be readily implemented, fully or partially, in software using, for example, assembly language, high level language, symbolic or graphical language, modeling language, and/or object or object-oriented software development environments that provide portable software code that can be used on a variety of computer platforms. Alternatively, embodiments of the disclosed method, system, and device for memory change track logging can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and device for memory change track logging can be implemented in hardware and/or software using any known or later developed systems or structures, devices and/or software by those of ordinary skill in the applicable art from the functional description provided herein and with a general basic knowledge of the computer and electrical arts.

Moreover, embodiments of the disclosed method, system, and device for memory change track logging can be implemented in software executed on a programmed general-purpose computer, a special purpose computer, a microprocessor, a microcontroller, a soft-core configured as a portion of an FPGA, or the like. Also, the memory change track logging method of this invention can be implemented as a program embedded on a personal computer such as a JAVA® or CGI script, as a resource residing on a server or graphics workstation, as a routine embedded in a dedicated processing system, or the like. The method and system can also be implemented by physically incorporating the method for memory change track logging into a software and/or hardware system, such as the hardware and/or software systems of a satellite.

It is, therefore, apparent that there is provided in accordance with the present invention, a method, system, and apparatus for memory change track logging. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A method for tracking changes in a memory of a system adapted for use onboard a spacecraft, the method comprising:
defining a change-track area of the memory including at least one memory address range for which changes will be tracked;
allocating a protected log region of memory for storing a change-track log;
selecting an operational mode for change tracking from among a plurality of modes having different criteria for tracking changes, the selected operational mode having selected criteria for tracking memory changes;
monitoring transactions occurring in the memory;
detecting, using a memory logging module, memory transactions that occur in the change-track area of memory and which meet the selected criteria;
generating a transaction record for each detected memory transaction; and
storing the transaction record in the change-track log,
wherein the plurality of operational modes includes a first mode in which only address of memory write operations are recorded, a second mode in which only addresses of memory read or write operations are recorded, a third mode in which addresses and data of memory write operations only are recorded, and a fourth mode in which addresses and data for read and write operations are recorded.

2. The method of claim 1, wherein the detecting, generating and storing are performed by a module introduced in a system by directly modifying software.

3. The method of claim 1, wherein the detecting, generating and storing are performed by a computer software module separate from the software for which memory transaction are being tracked.

4. The method of claim 1, further comprising reading the change-track log and modifying another memory based on the recorded changes in the change-track log.

5. The method of claim 1, wherein the monitoring of memory transactions is performed continuously.

6. The method of claim 1, wherein the tracking of memory changes is initiated in response to a signal.

7. The method of claim 1, wherein the generating further includes evaluating a data type for a memory transaction and determining whether to record the change based on a result of the evaluating.

8. The method of claim 1, wherein the transaction record includes control signal information.

9. A system for tracking memory changes, the system comprising:
a memory including a first region identified as a change-track region and a second region allocated as a protected log region, the change-track region comprising one or more memory areas for which changes will be tracked;
a processor coupled to the memory via an interconnection means; and
a memory transaction logging module adapted to:
provide an operational mode for tracking changes including address criteria for logging memory transactions,
detect memory transactions on the interconnection means, and
store transaction details for memory transactions directed to the change-track region of memory and which meet the criteria.

10. The system of claim 9, wherein the memory transaction logging module is disposed within the memory.

11. The system of claim 9, wherein the memory transaction logging module is disposed external to the memory and the processor and which is coupled to the interconnection means.

12. The system of claim 9, wherein the memory transaction logging module is isolated from the memory and the processor and the protected log region includes a local log portion and a remote log portion.

13. The system of claim 9, wherein the criteria includes the type of memory transaction and the type of data being handled that is subject to the memory transaction.

14. The system of claim 9, wherein the system is adapted for use onboard a satellite.

15. A system for data storage and retrieval, the system comprising:
means for describing a change-track area of memory including one or more address ranges;
means for providing data storage space for use as a protected change-track log;
means for selecting an operational mode for tracking memory changes having criteria for changes to be tracked;
means for detecting memory transactions that occur in the change-track area and which meets the criteria and generating an interrupt signal based on the detection of a transaction of interest; and
means for handling the interrupt signal by storing transaction information associated with the transaction of interest in the change-track log.

16. The system of claim 15, wherein the interrupt includes a software signal.

17. The system of claim 16, wherein the means for handling includes means for software interrupt handling.

18. The system of claim 15, wherein the interrupt includes a hardware signal.

19. The system of claim 18, wherein the means for handling includes means for hardware interrupt handling.

20. The system of claim 15, wherein means for selecting an operational mode includes means for selecting from among a plurality of operational modes including a first mode in which only addresses of memory write operations are recorded, a second mode in which only addresses of memory read or write operations are recorded, a third mode in which addresses and data of memory write operations only are recorded, and a fourth mode in which addresses and data for read and write operations are recorded.

21. The system of claim 9, wherein the change-track region include a plurality of memories adapted for storing memory transaction records in a hierarchical fashion.

22. The system of claim 9, wherein the processor forms one of a plurality of redundant processors and the stored transaction details for memory transactions are used to determine if any of the redundant processors is not synchronized with the others, and
wherein, when one of the redundant processors is determined not to be synchronized with the others, the one processor not synchronized is reset and restored to a current operating state by receiving and processing the stored transaction details.

23. The system of claim 9, wherein a region of interest of a cache memory is tagged with a cache coherency state for a given coherency scheme and the memory transaction logging module is further adapted to detect an incorrect operation request for the region of interest, and to provide updated data to another processor regarding a changed state of the region of interest.

24. The system of claim 9, wherein the memory transaction logging module is further adapted to ensure operating system security of certain sensitive regions of memory by having a hardware security check function such that a modification to a sensitive area of memory can be recorded and checked to ensure that safeguard measures are not being circumvented.

25. The system of claim 24, wherein the memory transaction logging module is further adapted to mitigate via a predefined sequence of actions, if a specified sensitive area of memory is accessed.

26. The system of claim 25, wherein the memory transaction logging module is further adapted to securely load sensitive data into and out of the memory space without making the sensitive data be available to software, the sensitive data being stored in and retrieved from an external device.

27. The system of claim 9, wherein the memory transaction logging module is further adapted to perform a check-pointing function and a rollback function, the check-pointing function being performed by periodically backing-up a state of the processor and current memory values to an external storage device, and when the processor is determined to be in a failed state, rollback function is executed to restore the processor to a previous state by loading the state of the processor and memory values stored during a previous check-pointing function.

28. The system of claim 27, wherein the memory transaction logging module is further adapted to periodically insert a delimiter into the log at predetermined checkpoint intervals, such that processor continues to function during a check-pointing function and processor downtime is reduced.

29. The system of claim 28, wherein only those memory values that have changed since a most recent check-pointing function are loaded back into memory during the rollback function.

30. The system of claim 9, wherein the memory transaction logging module is further adapted to determine errors in a transaction-based processing system in which correctness of processing is determined by comparing a final result output of a collection of operations that together form an atomic unit.

31. The system of claim 30, wherein the memory transaction logging module includes a function for comparing outputs of each of a plurality of sequential atomic processing groups.
